(19) United States
(12) Patent Application Publication
(10) Pub. No.: US 2025/0076182 A1
(43) Pub. Date: Mar. 6, 2025

(54) PORTABLE AND NON-DESTRUCTIVE CORROSION MONITORING SYSTEMS

(71) Applicant: Toyota Motor Engineering & Manufacturing North America, Inc., Plano, TX (US)

(72) Inventors: Victor Ponce Valderrama, College Station, TX (US); Shaik Merkatur Hakim Marjuban, College Station, TX (US); Homero Castaneda-Lopez, College Station, TX (US); Heather M. Eich, Ann Arbor, MI (US); Walter D. Tarr, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP); The Texas A&M University System, Bryan, TX (US)

(21) Appl. No.: 18/795,842

(22) Filed: Aug. 6, 2024

Related U.S. Application Data
(60) Provisional application No. 63/579,065, filed on Aug. 28, 2023.

(51) Int. Cl. G01N 17/04; G01N 17/00; G01N 17/02

(52) U.S. Cl. CPC G01N 17/04; G01N 17/006; G01N 17/02

(57) ABSTRACT

A corrosion monitoring system includes a processor, and a memory in communication with the processor and having a control module, a potentiostat, coupled to a clamp with a first plate and a second plate. The control module includes instructions that, when executed by the processor, cause the processor to control the potentiostat to apply a voltage to the first plate and the second plate during an EIS test of a coating on a metal substrate disposed between the first plate and the second plate. The corrosion monitoring system also monitors or detects a change in at least one of a phase angle and an impedance of the applied voltage, and identifies a change in corrosion activation at the substrate for any coating system based, at least in part, on the change in the at least one of the phase angle and the impedance.

### CROSS-REFERENCE TO RELATED APPLICATIONS

This application claims the benefit of U.S. Provisional Application No. 63/579,065, filed Aug. 28, 2023, which is incorporated herein in its entirety by reference.

### TECHNICAL FIELD

The present disclosure generally relates to corrosion monitoring systems, and particularly to systems for monitoring changes in the performance of barrier coatings with respect to corrosion.

### BACKGROUND

Corrosion monitoring apparatuses are used to identify and confirm coating defects in automotive coatings. Traditional laboratory corrosion monitoring apparatuses include test cells that require a liquid electrolyte to perform electrochemical impedance spectroscopy (EIS) testing on the coatings. The requirement of a liquid electrolyte makes the process of transporting the test cell offsite to test coatings difficult, meaning that coatings can often only be tested at predesignated locations.

The present disclosure addresses the issues of non-portable corrosion monitoring apparatuses, corrosion monitoring apparatuses that cannot be used in both wet and dry environments, and other issues related to corrosion monitoring apparatuses.

### SUMMARY

This section provides a general summary of the disclosure and is not a comprehensive disclosure of its full scope or its features.

In one form of the present disclosure, a system includes a processor and a memory in communication with the processor. The memory includes a control module having instructions that, when executed by the processor, cause the processor to control a potentiostat coupled to a clamp with a first plate and a second plate to apply a voltage to the first plate and the second plate during an electrochemical impedance spectroscopy (EIS) test of a coating on a metal substrate disposed between the first plate and the second plate by forming a natural capacitor. The control module further includes instructions that, when executed by the processor, cause the processor to monitor a change in at least one of a phase angle and an impedance of the applied voltage. Moreover, the control module further includes instructions that, when executed by the processor, cause the processor to identify a change in corrosion of at least one of the coating and the metal substrate based, at least in part, on the change in the at least one of the phase angle and the impedance.

In another form of the present disclosure, a system includes a processor and memory in communication with the processor. The memory includes a control module having instructions that, when executed by the processor, cause the processor to control a potentiostat coupled to a clamp with a first plate and a second plate to apply an AC voltage to the first plate and the second plate during an EIS test of a coating on a metal substrate disposed between the first plate and the second plate. The control module further includes instructions that, when executed by the processor, cause the processor to monitor a change in at least one of a phase angle and an impedance of the applied voltage, and cause the clamp to apply a constant pressure to at least one of the coating and the metal substrate during the EIS test. Moreover, the control module further includes instructions that, when executed by the processor, cause the processor to identify a change in corrosion of at least one of the coating and the metal substrate based, at least in part, on the change in the at least one of the phase angle and the impedance.

In still another form of the present disclosure, a system includes a processor and a memory in communication with the processor. The memory includes a control module having instructions that, when executed by the processor, cause the processor to control a potentiostat coupled to a clamp with a first plate and a second plate to apply an AC voltage to the first plate and the second plate during an EIS test of a coating on a metal substrate disposed between the first plate and the second plate. The control module further includes instructions that, when executed by the processor, cause the clamp to apply a constant pressure to the at least one of the coating and the metal substrate during the EIS test and cause the processor to monitor a change in at least one of a phase angle and an impedance of the applied voltage. Moreover, the control module includes instructions that, when executed by the processor, cause the processor to identify a change in corrosion of at least one of the coating and the metal substrate based, at least in part, on the change in the at least one of the phase angle and the impedance, and identify a start of corrosion activation of the metal substrate based, at least in part, on the change in the at least one of the phase angle and the impedance.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 is a block diagram of a corrosion monitoring system according to the teachings of the present disclosure;

FIG. 2 is one form of a corrosion monitoring system according to the teachings of the present disclosure;

FIG. 3 illustrates a sequence of steps during corrosion of a barrier coating on a substrate;

FIG. 4 is a plot of expected phase angle versus frequency for an electrochemical impedance spectroscopy (EIS) test on the barrier coating shown in FIG. 3;

FIG. 5A is a plot of phase angle versus frequency for a wet-dry cycle EIS test on a 10 micrometer (μm) barrier coating with 0% scratch;

FIG. 5B is a plot of phase angle versus frequency for a wet-dry cycle EIS test on a 10 μm barrier coating with 50% scratch;

FIG. 5C is a plot of phase angle versus frequency for a wet-dry cycle EIS test on a 10 μm barrier coating with 100% scratch;

FIG. 6A is a plot of phase angle versus frequency for a wet-dry cycle EIS test on a 25 μm barrier coating with 0% scratch;

FIG. 6B is a plot of phase angle versus frequency for a wet-dry cycle EIS test on a 25 μm barrier coating with 50% scratch;

FIG. 6C is a plot of phase angle versus frequency for a wet-dry cycle EIS test on a 25 μm barrier coating with 100% scratch;

FIG. 7 illustrates a sequence of steps during corrosion of a sacrificial barrier coating on a substrate;

FIG. 8 is a plot of expected phase angle versus frequency measured for an EIS test on the sacrificial coating of FIG. 7;

FIG. 9 illustrates a sequence of steps during corrosion of a hybrid coating on a substrate;

FIG. 10 is a plot of expected phase angle versus frequency measured for an EIS test on the hybrid coating of FIG. 9;

FIG. 11A is a plot of phase angle versus frequency for a wet-dry cycle EIS test on a 30 μm hybrid coating with 0% scratch;

FIG. 11B is a plot of phase angle versus frequency for a wet-dry cycle EIS test on a 30 μm hybrid coating with 50% scratch;

FIG. 11C is a plot of phase angle versus frequency for a wet-dry cycle EIS test on a 30 μm hybrid coating with 100% scratch;

FIG. 12A is a plot of impedance versus frequency for a wet-dry cycle EIS test on a 25 μm barrier coating with 0% scratch;

FIG. 12B is a plot of impedance versus frequency for a wet-dry cycle EIS test on a 25 μm barrier coating with 50% scratch; and

FIG. 12C is a plot of impedance versus frequency for a wet-dry cycle EIS test on a 25 μm barrier coating with 100% scratch.

### DETAILED DESCRIPTION

The present disclosure provides a system for measuring corrosion and/or deterioration of a coating on a substrate and corrosion of the substrate if and when corrosion occurs. In some variations, the coating is an automotive coating, e.g., a coating on an automobile panel. In at least one variation, the system includes a capacitor-like sensor in the form of a clamp with a first plate and a second plate. The two plates act or function as a conductive material of the sensor, and can be copper plates, copper alloy plates, aluminum plates, aluminum alloy plates, and/or any suitable material that acts or functions as a conductive material of a capacitor-like sensor. In some variations, the clamp grasps opposite sides or faces of a substrate with a coating, and the coating acts or functions as a dielectric material/layer between the first plate and the second plate.

In some variations, the clamp grasps opposite sides or faces of a substrate with a coating such that the first plate is in direct contact with the coating and the second plate is direct contact with the substrate (or the opposite side of the coating), or vice versa, and an alternating current (AC) signal is transmitted to the first plate and the second plate during electrochemical impedance spectroscopy (EIS) testing. In at least one variation, the first plate and the second plate have an equal area of contact with the coating and substrate, respectively, and a potentiostat is connected to the first plate and the second plate such that a test cell for AC evaluation via EIS testing is formed. The AC signal includes a potential input and a current output with frequency dependency and results in terms of transfer function or impedance. Further, the AC signal provides a phase angle or change in phase angle that identifies when and if deterioration of the coating or corrosion of the substrate occurs.

As used herein, the term “potentiostat” refers to a control and measuring device with an electric circuit that controls the potential (voltage) across an electrochemical cell by sensing changes in resistance across the electrochemical cell and changing the current applied across the electrochemical cell such that the voltage remains constant.

In some variations, the system is used to measure degradation or performance of a coating and the corrosion of a substrate in both wet and dry environments. A dry environment is, for example, any environment with a low relative humidity and minimal moisture presence (e.g., in a storage facility, manufacturing site, etc.). Wet environments include both full immersion wet environments (e.g., in underwater environments) or cyclically wet environments (e.g., in environments where the coatings are temporarily wet, and then dry).

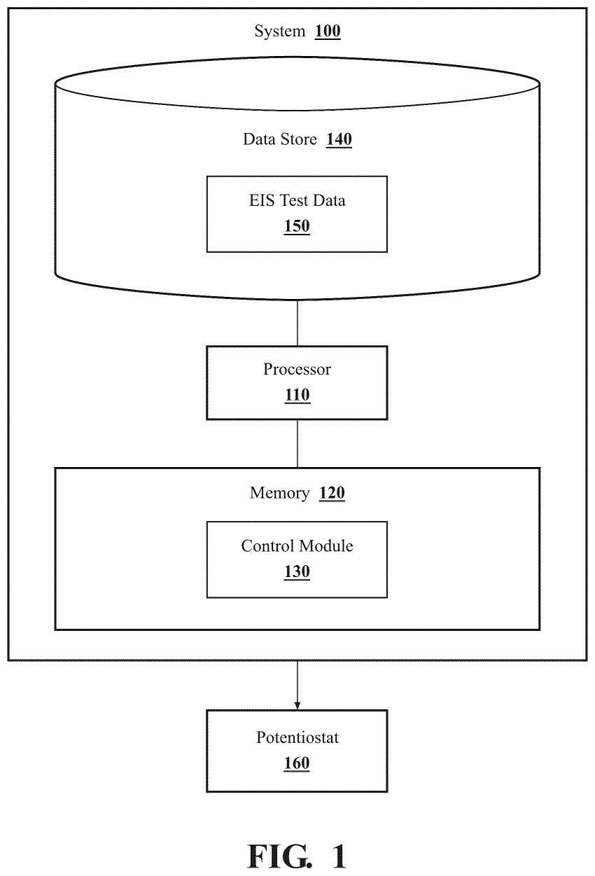

Referring to FIG. 1, a system 100 for monitoring corrosion of a coating disposed on a substrate is disclosed. The system 100 is shown as including a processor 110. The processor 110 may be a part of the system 100 or the system 100 may access the processor 110 through a data bus or another communication path. In one variation, the system 100 includes a memory 120 that stores a control module 130. The memory 120 is a random-access memory (RAM), read-only memory (ROM), a hard-disk drive, a flash memory, or other suitable memory for storing the control module 130. The control module 130 is, for example, computer-readable instructions that when executed by the processor 110 cause the processor 110 to perform the various functions disclosed herein.

The control module 130 generally includes instructions that function to control the processor 110 to receive data inputs from a potentiostat 160 connected to a clamp that grasps a sample with a coating. The inputs are, in one or more variations, information associated with the electrochemical behavior of the coating/substrate during an EIS test (e.g., the applied AC voltage signal across the test cell, the resulting AC response induced by the applied AC voltage, the frequency of the applied AC voltage, impedance data, a phase angle, etc.). As provided for herein, the control module 130 acquires EIS test data 150 (also referred to herein as “sensor data 150”) that includes at least the frequency of an applied AC voltage during an EIS test and a measured current during the EIS test. Accordingly, the control module 130, in one embodiment, controls the potentiostat 160 to provide the data inputs in the form of the sensor data 150.

Moreover, in one or more non-limiting examples, the system 100 includes a data store 140. In one configuration, the data store 140 is a database. The database is, in one variation, an electronic data structure stored in the memory 120 or another data store that is configured with routines that can be executed by the processor 110 for analyzing stored data, providing stored data, organizing stored data, and so on. Thus, in one non-limiting example, the data store 140 stores data used by the control module 130 in executing various functions.

The control module 130, in one or more variations, is further configured to perform additional tasks beyond controlling the respective potentiostat to acquire and provide the sensor data 150. For example, the control module 130 includes instructions that cause the processor 110 to apply a voltage to a first plate and a second plate of a clamp coupled to the potentiostat 160 during an EIS test of a coating on a metal substrate disposed between the first plate and the second plate. In order to properly facilitate the EIS test and to acquire the EIS test data 150 in a consistent manner, the control module 130, in some variations, includes instructions that cause the processor 110 to cause the clamp to apply a constant pressure to the coating and/or the metal substrate during the EIS test. For example, the EIS test may be performed at different times over the course of a day, several days, a month, etc. Accordingly, in one non-limiting example, the control module 130 causes the processor 110 to apply the same pressure each time a voltage is applied to the clamp and to apply the same pressure across both plates the entire time the voltage is applied to the clamp.

In one non-limiting example, the control module 130 further includes instructions that cause the processor 110 to monitor a change in at least one of a phase angle and an impedance of the applied voltage. In particular, in one or more variations, control module 130 includes instructions that cause the processor 110 to calculate the phase angle and impedance of the coating during the EIS test based on the acquired sensor data 150. For example, in one or more forms, the potentiostat 160 acquires the sensor data 150 associated with the AC current response (e.g., the magnitude and phase of the AC current) during AC voltage application. In response to acquiring the AC current response, the processor 110, in one or more variations, calculates the impedance using Ohm's law where impedance is calculated as the ratio of the applied AC voltage to the measured AC current at defined frequency points. Additionally, in one form, the processor 110 calculates the phase angle based on the AC current response, where the phase angle represents the phase shift between the applied AC voltage and the AC current response. In any case, the control module 130, in one or more variations, includes instructions that cause the processor 110 to plot the impedance or phase angle versus the frequency measured during the EIS test.

In some variations, the control module 130 includes instructions that cause the processor 110 to monitor the change in corrosion of the coating and/or the substrate in different environments. For example, the processor 110 may, in one or more non-limiting examples, monitor the change in corrosion in a dry, wet, or cyclically wet environment.

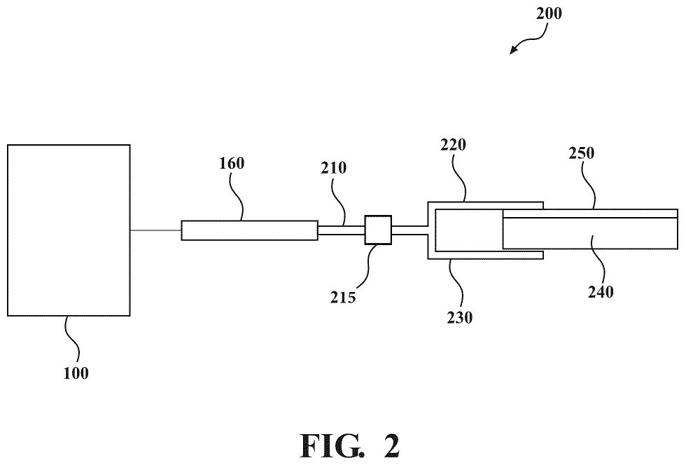

In one or more variations, the control module 130 further includes instructions that, when executed by the processor 110, cause the processor 110 to identify a change in the degradation of the coating and/or the corrosion of the metal substrate based, at least in part, on the change in the phase angle and/or the impedance. For example, the instructions may include instructions to cause the processor 110 to analyze a plot of the impedance or phase angle versus the frequency measuring during an EIS test. In response to analyzing the plot, the processor 110 may identify a curve associated with the phase angle or impedance or peaks in the phase angle or impedance (i.e., a maximum/minimum phase angle or impedance). In one non-limiting example, the control module 130 includes instructions that cause the processor 110 to responsive to identifying a peak in at least the phase angle and the impedance, identify a start of corrosion of the coating and/or the substrate. A start of corrosion is, for example, the time at which the coating and/or the substrate begins to corrode/degrade due to an external environmental condition (e.g., exposure to water or some other solution). Discussion will now turn to FIG. 2 to further discuss the physical set-up of the system 100 during an EIS test.

Referring to FIG. 2, a corrosion monitoring system 200 is shown. The corrosion monitoring system 200 is, for example, an EIS test system, where the EIS test may be performed in a lab environment or in the field (i.e., outside of lab in a non-controlled environment). Further, as previously discussed, the EIS test may be performed in a dry, wet, or cyclically wet environment. Accordingly, the corrosion monitoring system 200 is, in one or more forms, is configured to measure corrosion in any dry, wet, or cyclically wet environment.

The corrosion monitoring system 200 includes the system 100 and the potentiostat 160 previously discussed in relation to FIG. 1. The potentiostat 160 is, in one or more variations, coupled to a clamp 210 that includes a first plate 220 and a second plate 230. In some variations, the clamp 210 includes and tightening/loosening mechanism 215 configured to move the first plate and the second plate closer to each other and/or further apart from each other.

The first plate 220 and the second plate 230 are, in one or more variations, formed from the same material. In some variations, the first plate 220 and the second plate 230 include metal coatings or are made from a metallic material that allow the first plate 220 and the second plate 230 to act as a conductive material and/or electrodes during an EIS test. For example, in some variations, the first plate 220 and the second plate 230 are copper plates or plates with a copper coating. In at least one variation, the corrosion monitoring system 200 is portable. In particular, the clamp 210 is a portable device capable of being used in a lab environment as well as in a field external to a lab.

In some variations, the corrosion monitoring system 200 is configured to clamp onto a substrate 240 with a coating 250 disposed on the substrate 240. That is, the first plate 220 and the second plate 230 grasp the substrate 240 and coating 250 as illustrated in FIG. 2 such that the substrate 240 and/or the coating 250 is sandwiched between the first plate 220 and the second plate 230. And in at least one variation, the control module 130 includes instructions that cause the processor 110 to command the tightening/loosening mechanism 215 to move the first plate 220 and/or the second plate such that a constant pressure is applied across the substrate 240 and the coating 250.

The substrate 240 is, in one or more non-limiting examples, a metal substrate (e.g., aluminum, brass, zinc, steel, etc.). In some variations, the coating 250 is an automotive coating (e.g., an automotive paint coating). For example, in at least one variation the coating 250 is an e-coat, where the e-coat is an epoxy polymer coating. In other variations, the coating 250 is a zinc-containing (e.g., zinc-nickel) coating. In still other variations, the coating 250 is a hybrid coating with both an epoxy polymer coating (e.g., e-coat) and a zinc-containing coating. In any case, in one or more variations, the clamp 210 is configured to grasp onto the substrate 240 and the coating 250.

In some variations, the clamp 210 grasps opposite sides of the substrate 240, where a first side of the substrate 240 includes the coating 250 and the second side of the substrate 240 does not include the coating. And in such variations, the coating 250 acts as the dielectric material for the EIS test, one of the plates (e.g., first plate 220) directly contacts the coating 250 and the other plate (e.g., second plate 230) directly contacts the substrate 240. Accordingly, the corrosion monitoring system 200 enables the system 100 to facilitate an EIS test by controlling the potentiostat 160 to apply a voltage to the clamp 210 such that the clamp 210 operates or functions as a capacitive sensor. And although not shown, in some variations the clamp 210 grasps opposite sides of a substrate 240 that includes a coating 250 on both sides of the substrate 240.

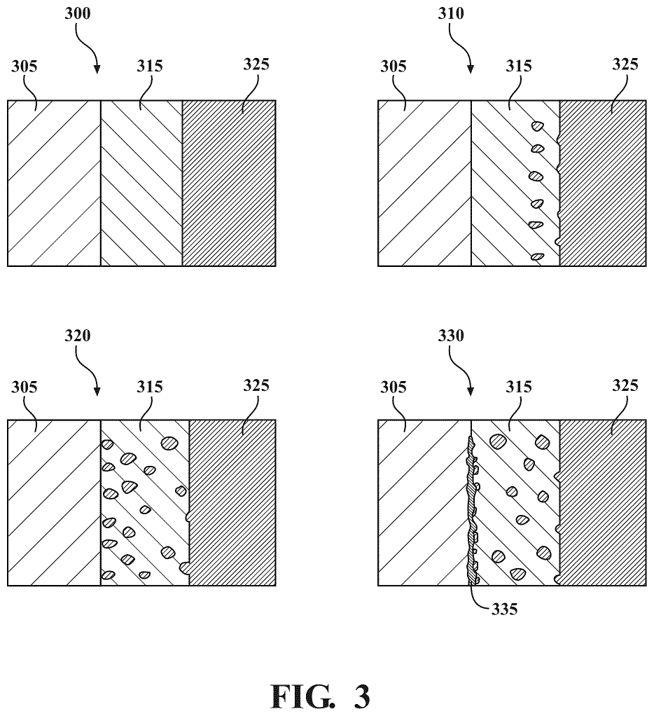

Referring to FIG. 3, illustration of a time sequence associated with corrosion of a barrier coating on a substrate is shown. Particular, timestep 300 shows a substrate 305, such as a metal substrate discussed in relation to FIG. 2, with a barrier coating 315. The barrier coating 315 is, for example, an e-coat (e.g., an epoxy polypropylene coating). The barrier coating 315 is disposed on a surface of the substrate 305 and the coating 315 is in contact with a corrosive solution 325. As shown at timestep 300, the solution 325 has not penetrated the surface of the coating 315, and as such, the substrate 305 and the coating 315 have not begun to corrode or deteriorate. At timestep 310, the solution 325 has penetrated the coating 315. However, the solution 325 has not reached the substrate 305. At timestep 320, the solution 325 has increased its penetration of the coating 315 and just reached the substrate 305. And at timestep 330, the solution 325 has started to corrode the substrate 305 to form a corrosion product 335 (e.g., an oxide scale).

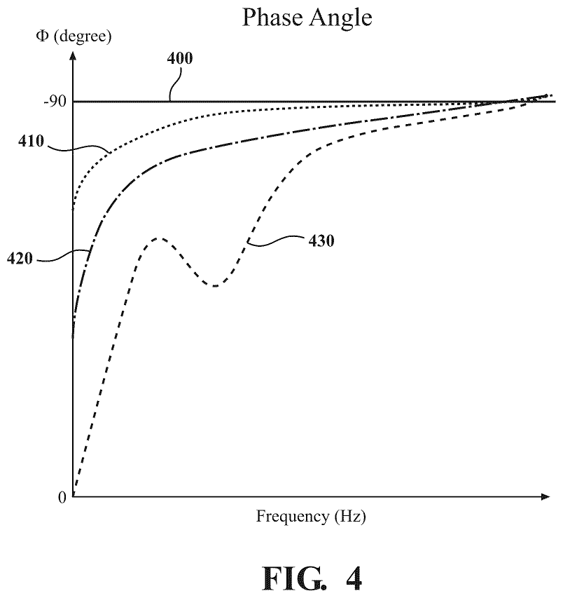

Referring to FIG. 4, a plot of expected phase angle (degree) versus frequency (Hertz (Hz)) during EIS testing of the barrier coating shown in FIG. 3 is shown. The plot includes lines 400, 410, 420, and 430 corresponding to timesteps 300, 310, 320, and 330, respectively. At timestep 300, and as illustrated by line 400, the phase angle remains constant since the solution 325 has not penetrated the coating 315. At time step 310, and as illustrated by line 410, the phase angle has or develops a slight curve at lower frequencies as the solution 325 begins to penetrate and alter the dielectric properties of the coating 315. At time step 320, and as illustrated by line 420, the phase angle has or develops a steeper curve at lower frequencies as the solution 325 continues to penetrate the coating 315 and reaches the substrate 305. And at time step 330 (line 430), the phase angle has or develops a develop maximum and minimum as the corrosion product 335 forms on the substrate 305. Accordingly, a plot of phase angle versus frequency for an EIS test on a substrate-barrier coating system using the corrosion monitoring system 200 provides at least three distinct line shapes associated with: (1) a barrier coating without environment penetration and acting as a perfect dielectric layer (line 400); (2) a barrier coating with environment penetration and exhibiting a loss of dielectric properties (lines 410, 420); and a barrier coating fully penetrated by an environment and corrosion occurring at the underling substrate (line 430).

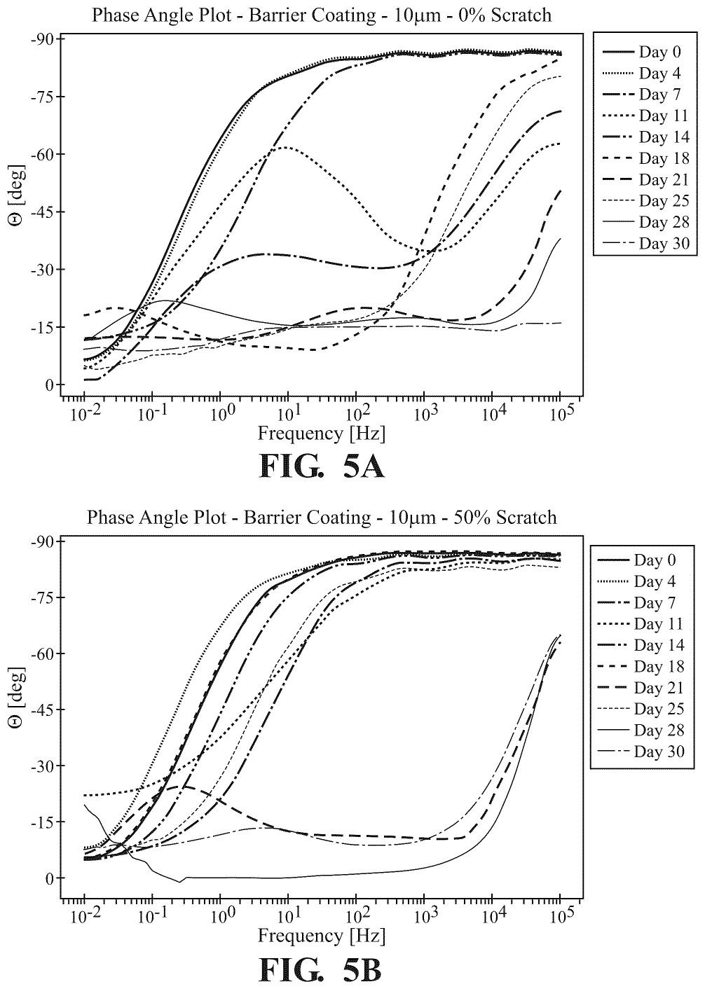

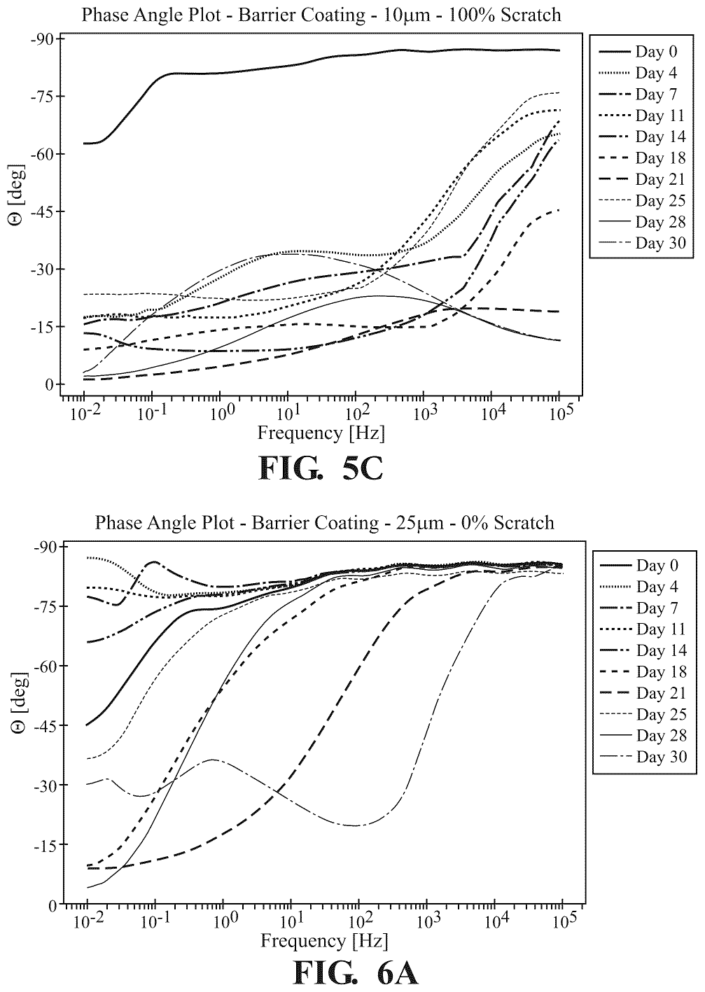

Referring now to FIGS. 5A-5C, plots of phase angle versus frequency measured during EIS testing on a 10 micrometer (μm) barrier coating using the corrosion monitoring system 200 are shown. The barrier coating was a polymer-based material with no physical imperfections (e.g., scratches, holes, etc.) on a phosphate pretreated metallic substrate. Also, the barrier coating was exposed to a 5 wt % NaCl solution with a pH between about 5.8 and about 6.3 at 30° C., and a potentiostat of the corrosion monitoring system 200 provided a 10 mV AC voltage at frequencies between about 0.01 to about 100,000 Hz to the first plate 220 and the second plate 230 of the clamp 210. The EIS testing included a wet-dry test of the barrier coating without a scratch (0% scratch), a wet-dry test of the barrier coating with a 5 μm deep scratch (50% scratch), and a wet-dry test of the barrier coating with a 10 μm deep scratch (100% scratch). The wet-dry test consisted of cycles of 96 hours in a humid environment with the 5 wt % NaCl solution followed by 72 hours in a dry environment, for a total of 30 days (720 hours).

Referring to FIG. 5A, a first peak in phase angle for a 0% scratch barrier coating subjected to the wet-dry test appeared at day 11, thereby indicating the substrate with a 10 μm 0% scratch barrier coating began to corrode on day 11. As shown in FIG. 5B, a first peak in phase angle appeared at day 21, thereby indicating the substrate with the 10 μm 50% barrier coating began to corrode at day 21, and as shown in FIG. 5C, a first peak in phase angle appeared at day 4, thereby indicating the substrate with a 10 μm 100% scratch barrier coating began to corrode at day 4. And while the results illustrate inconsistencies with 10 μm thick coatings (i.e., the 10 μm thick coating with a 50% scratch appeared to outperform the 10 μm thick coating with 0% scratch), the corrosion monitoring system 200 discussed in relation to FIG. 2 successfully identified the start of corrosion for substrates with a barrier coating.

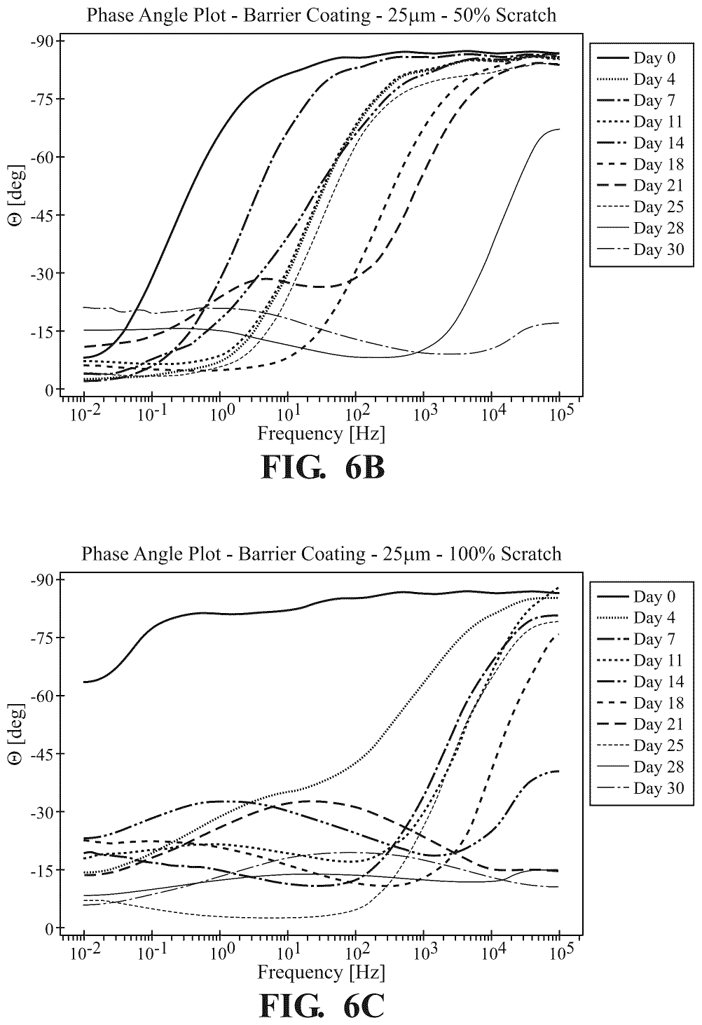

Referring to FIGS. 6A-6D, plots of phase angle versus frequency measured during EIS testing on a 25 μm barrier coating are shown. The barrier coating was on a steel substrate. Also, the barrier coating was exposed to a 5 wt % NaCl solution with a pH between about 5.8 and about 6.3 at 30° C., and a potentiostat of the corrosion monitoring system 200 provided a 10 mV AC voltage at frequencies between about 0.01 to about 100,000 Hz to the first plate 220 and the second plate 230 of the clamp 210. The EIS testing included a wet-dry test of the barrier coating without a scratch (0% scratch), a wet-dry test of the barrier coating with a 12.5 μm deep scratch (50% scratch), and a wet-dry test of the barrier coating with a 25 μm deep scratch (100% scratch). The wet-dry test consisted of cycles of 96 hours in a humid environment with the 5 wt % NaCl solution followed by 72 hours in a dry environment, for a total of 30 days (720 hours).

Referring to FIG. 6A, a first peak in phase angle for a 25 μm 0% scratch barrier coating subjected to the wet-dry test appeared at day 30, thereby indicating the substrate with the 25 μm 0% scratch barrier coating began to corrode on day 30. As shown in FIG. 6B, a first peak in phase angle appeared at day 21, thereby indicating the substrate with the 25 μm 50% barrier coating began to corrode at day 21, and as shown in FIG. 6C, a first peak in phase angle appeared at day 4, thereby indicating the substrate with a 10 μm 100% scratch barrier coating began to corrode at day 4. Accordingly, the corrosion monitoring system 200 discussed in relation to FIG. 2 successfully identifies the start of corrosion for substrates with barrier coatings of different thicknesses.

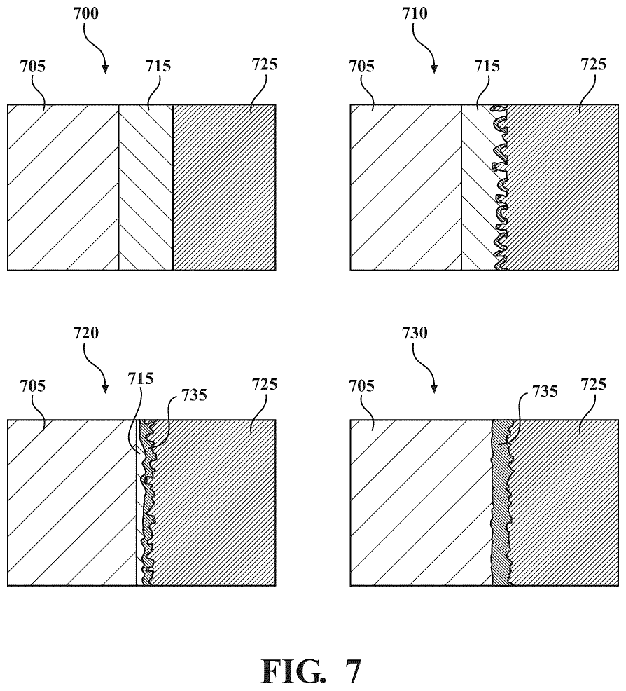

Referring to FIG. 7, illustration of a time sequence associated with corrosion of a sacrificial coating on a substrate is shown. Particularly, at timestep 700, a substrate 705, such as a metal substrate discussed in relation to FIG. 2 with a sacrificial coating 715 is shown. The sacrificial coating 715 can be, e.g., a zinc-nickel coating and thus is an electrically conductive coating. The sacrificial coating 715 is disposed on a surface of the substrate 705 and the sacrificial coating 715 is in contact with a water-based corrosive solution 725. As shown at timestep 700, the solution 725 has not penetrated the surface of the sacrificial coating 715, and as such, the substrate 705 has not begun to corrode. At timestep 710, the solution 725 has started corroding the sacrificial coating 715, however, the solution 725 has not reached the substrate 705. At timestep 720, the solution 725 has further corroded the sacrificial coating 715, and at timestep 730 the solution 725 has reached and started corroding the substrate 705 such that a passive oxide layer has formed.

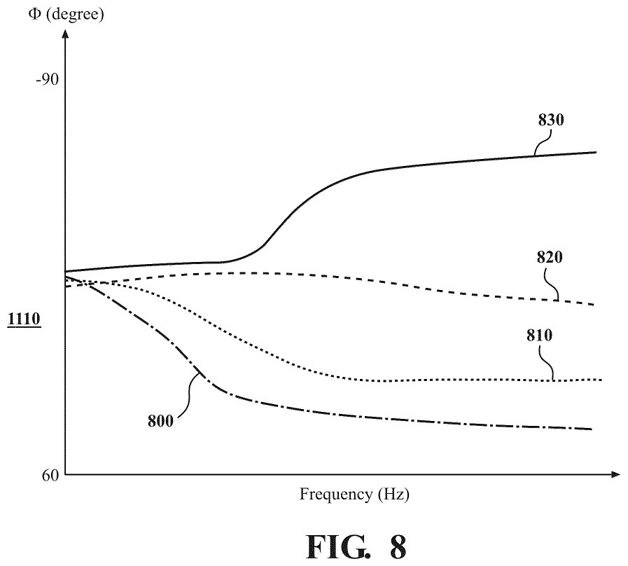

Referring to FIG. 8, a plot of expected phase angle versus frequency during EIS testing of the sacrificial coating illustrated in FIG. 7 is shown. The plot includes lines 800, 810, 820, and 820 that correspond to timesteps 700, 710, 720, and 730, respectively. And as illustrated in FIG. 8, line 800 illustrates a phase angle versus frequency shape for the sacrificial coating 715 having not yet experienced corrosion, line 810 illustrates a phase angle versus frequency shape expected for the sacrificial coating 715 experiencing the early stages of sacrificial corrosion, line 820 illustrates a phase angle versus frequency shape expected for the sacrificial coating 715 experiencing advanced stages of corrosion including passive layer formation, and line 830 illustrates a phase angle versus frequency shape expected for compete corrosion of the sacrificial coating 715 and passive layer formation.

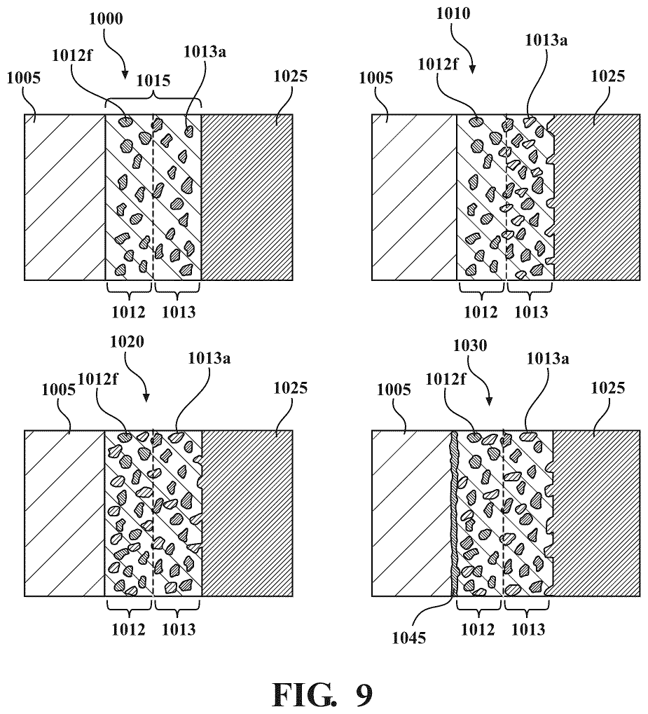

Referring to FIG. 9, illustration of a time sequence associated with corrosion of a coating formed from a zinc flake basecoat with an organic topcoat with aluminum particles (hereafter referred to collectively as a “hybrid coating”) on a substrate is shown. Particularly, at timestep 1000, a substrate 1005, such as a metal substrate discussed in relation to FIG. 2, is shown with a hybrid coating 1015. The hybrid coating 1015 includes a basecoat 1012 with zinc flakes 1012f and an organic topcoat 1013 with aluminum particles 1013a, and is disposed on a surface of the substrate 1005. Also, the hybrid coating 1015 is in contact with a water-based corrosive solution 1025. As shown at timestep 1000, the solution 1025 has not penetrated the surface of the hybrid coating 1015, and as such, the substrate 1005 and the hybrid coating 1015 have not begun to corrode. At timestep 1010, the solution 1025 has started corroding the hybrid coating 1015 and formed a corrosion product on the aluminum particles 1013a in the organic topcoat 1013, but has not reached the basecoat 1012. At timestep 1020, the solution 1025 has further corroded the hybrid coating 1015 and formed a corrosion product on the zinc flakes 10112f, and at timestep 1030 the solution 1025 has reached and started corroding the substrate 1005 with corrosion product 1045 forming.

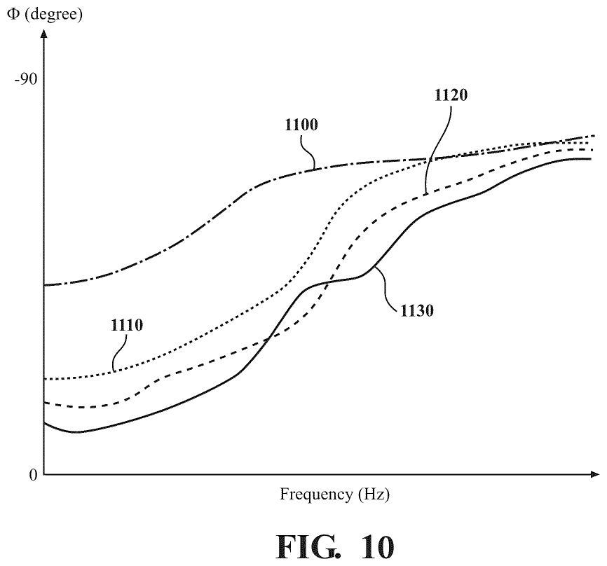

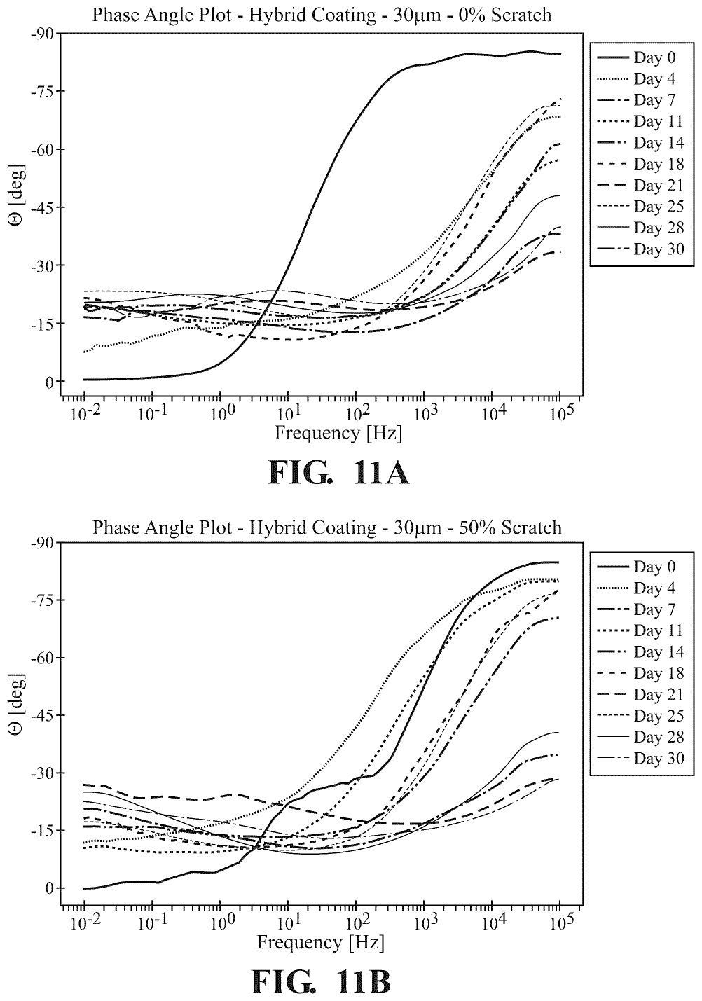

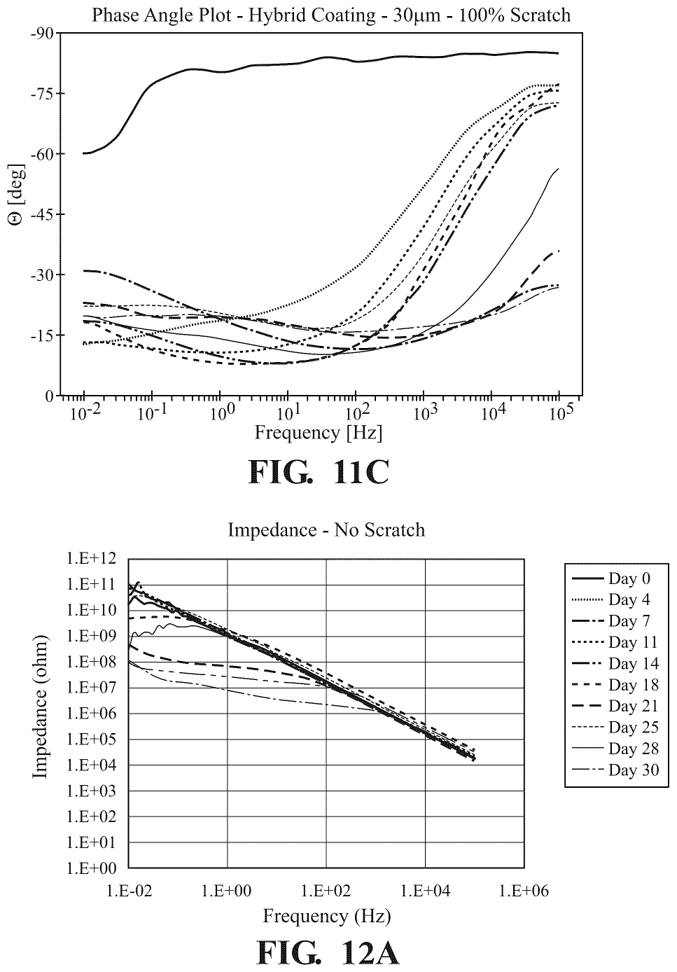

Referring to FIG. 10, a plot of expected phase angle versus frequency during EIS testing of the sacrificial coating illustrated in FIG. 10 is shown. The plot includes lines 1100, 1110, 1120, and 1130 that correspond to timesteps 1000, 1010, 1020, and 1030, respectively. And as illustrated in FIG. 11, line 1100 illustrates a phase angle versus frequency shape for the hybrid coating 1015 having not yet experienced corrosion, line 1110 illustrates a phase angle versus frequency shape expected for the hybrid coating 1015 experiencing the early stages of corrosion, line 1120 illustrates a phase angle versus frequency shape expected for the hybrid coating 1015 experiencing advanced stages of corrosion, and line 1130 illustrates a phase angle versus frequency shape expected for compete corrosion of the hybrid coating 1015 and corrosion of the substrate 1005 occurring.

Referring now to FIGS. 11A-11C, plots of phase angle versus frequency measured for EIS testing of a 30 μm thick hybrid coating with 0% scratch, EIS testing of a 30 μm hybrid coating with 50% scratch, and EIS testing of a 30 μm hybrid coating with 100% scratch are shown, respectively. The hybrid coating was exposed to a 5 wt % NaCl solution with a pH between about 5.8 and about 6.3 at 30° C., and a potentiostat of the corrosion monitoring system 200 provided a 10 mV AC voltage at frequencies between about 0.01 to about 100,000 Hz to the first plate 220 and the second plate 230 of the clamp 210. The EIS testing included a wet-dry test consisting of cycles of 96 hours in a humid environment with the 5 wt % NaCl solution followed by 72 hours in a dry environment, for a total of 30 days (720 hours).

As shown in FIG. 11A, the substrate with a 30 μm 0% scratch hybrid coating began to corrode on day 21. As shown in FIG. 11B, the substrate with a 30 μm 50% hybrid coating began to corrode at day 18. As shown in FIG. 11C, the substrate with a 30 μm 100% scratch hybrid coating began to corrode at day 18. Accordingly, the corrosion monitoring system 200 discussed in relation to FIGS. 1 and 2 successfully identifies the start of corrosion for substrates with hybrid coatings.

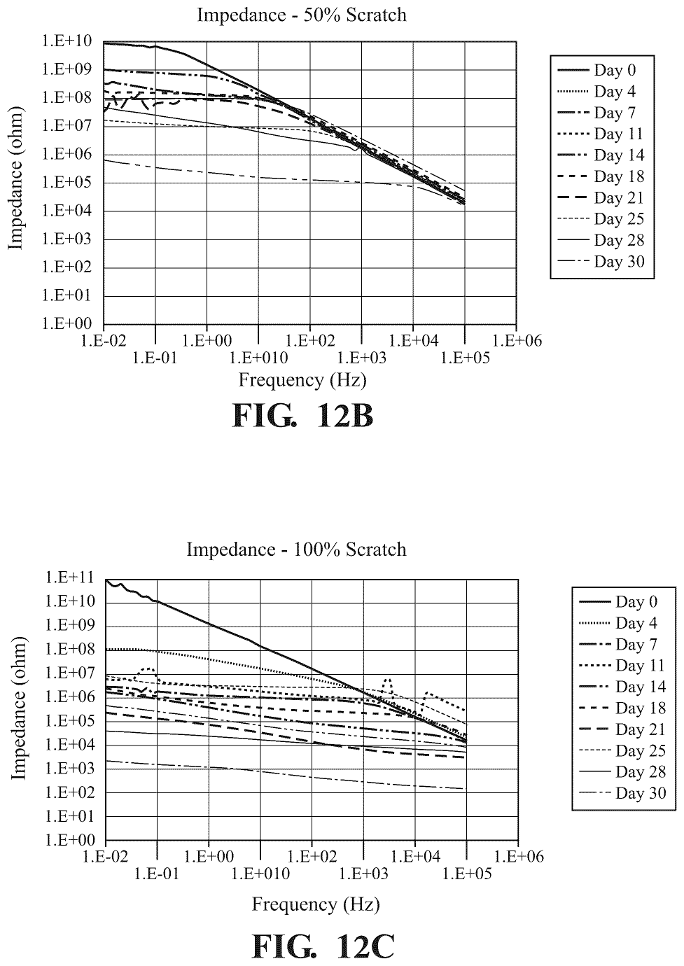

It should be understood that while the corrosion monitoring system 200 has been described as using plots phase angle as a function of frequency to monitor and/or identify corrosion, the corrosion monitoring system 200 can also plots or data of impedance as a function of frequency to monitor and/or identify corrosion. For example, and with reference to FIGS. 12A-12C, plots of impedance versus frequency for EIS testing on a 25 μm barrier coating with 0% scratch, a 25 μm barrier coating with 50% scratch, and a 25 μm barrier coating with 100% scratch, respectively, are shown. For each EIS test, a 25 μm barrier coating (e.g., an e-coat coating) was applied to a substrate and the testing environment a 5 wt % NaCl solution with a pH between about 5.8 and about 6.3, at 30° C., and a potentiostat of the corrosion monitoring system 200 provided a 10 mV AC voltage at frequencies between about 0.01 to about 100,000 Hz to the first plate 220 and the second plate 230 of the clamp 210. The EIS testing included a wet-dry test consisting of cycles of 96 hours in a humid environment with the 5 wt % NaCl solution followed by 72 hours in a dry environment, for a total of 30 days (720 hours).

Referring particularly to FIG. 12A, the substrate with a 25 μm 0% scratch barrier coating began to corrode on day 18, corrode more between day 18 and day 21, exhibited passivation (day 25), and then further substrate activation thereafter (days 28 and 30). As shown in FIG. 12B, the substrate with a 25 μm 50% barrier coating exhibited corrosion at day 7, passivated between day 7 and day 14, followed by substrate activation. And as shown in FIG. 12C, the substrate with a 25 μm 100% scratch barrier coating began to corrode at day 4. Accordingly, the corrosion monitoring system 200 discussed in relation to FIGS. 1 and 2 successfully identifies the start of corrosion for substrates with coatings using plots or data of impedance as a function of frequency.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A system comprising:
a processor; and
a memory in communication with the processor and having a control module, the control module having instructions that, when executed by the processor, cause the processor to:
control a potentiostat coupled to a clamp with a first plate and a second plate to apply a voltage to the first plate and the second plate during an electrochemical impedance spectroscopy (EIS) test of a coating on a metal substrate disposed between the first plate and the second plate;
monitor a change in at least one of a phase angle and an impedance of the applied voltage; and
identify a change in corrosion of at least one of the coating and the metal substrate based, at least in part, on the change in the at least one of the phase angle and the impedance.

2. The system of claim 1, wherein the first plate and the second plate are copper plates.

3. The system of claim 1, wherein the coating is sandwiched between the first plate and the second plate.

4. The system of claim 1, wherein the coating is an automotive coating.

5. The system of claim 1, wherein the coating is an epoxy polymer coating.

6. The system of claim 1, wherein the coating is a zinc-nickel coating.

7. The system of claim 1, wherein the coating is a zinc flake basecoat with an organic topcoat.

8. The system of claim 1, further including instructions that, when executed by the processor, cause the processor to cause the clamp to apply a constant pressure to the at least one of the coating and the metal substrate during the EIS test.

9. The system of claim 1, wherein the instructions to monitor the change in corrosion further include instructions that, when executed by the processor, cause the processor to monitor the corrosion in a dry environment.

10. The system of claim 1, wherein the instructions to monitor the change in corrosion further include instructions that, when executed by the processor, cause the processor to monitor the corrosion in a wet environment.

11. The system of claim 1, wherein the instructions to monitor the change in corrosion further include instructions that, when executed by the processor, cause the processor to monitor the corrosion in a cyclically wet environment.

12. The system of claim 1, further including instructions that, when executed by the processor, cause the processor to:
responsive to identifying a peak in at least the phase angle and the impedance, identify a start of the corrosion of the at least one of the coating and the metal substrate.

13. The system of claim 1, wherein the clamp is a portable device.

14. A system comprising:
a processor; and
a memory in communication with the processor and having a control module, the control module having instructions that, when executed by the processor, cause the processor to:
control a potentiostat coupled to a clamp with a first plate and a second plate to apply a voltage to the first plate and the second plate of the clamp during an electrochemical impedance spectroscopy (EIS) test of a coating on a metal substrate disposed between the first plate and the second plate;
monitor a change in at least one of a phase angle and an impedance of the applied voltage;
cause the clamp to apply a constant pressure to at least one of the coating and the metal substrate during the EIS test; and
identify a change in corrosion of at least one of the and the metal substrate based, at least in part, on the change in the at least one of the phase angle and the impedance.

15. The system of claim 14, wherein the coating is sandwiched between the first plate and the second plate.

16. The system of claim 14, wherein the instructions to monitor the change in corrosion further include instructions that, when executed by the processor, cause the processor to monitor the corrosion in a dry environment.

17. The system of claim 14, wherein the instructions to monitor the change in corrosion further include instructions that, when executed by the processor, cause the processor to monitor the corrosion in a wet environment.

18. The system of claim 14, wherein the instructions to monitor the change in corrosion further include instructions that, when executed by the processor, cause the processor to monitor the corrosion in a cyclically wet environment.

19. The system of claim 14, further including instructions that, when executed by the processor, cause the processor to:
responsive to identifying a peak in at least the phase angle and the impedance, identify a start of substrate activation and coating degradation.

20. A system comprising:
a processor; and
a memory in communication with the processor and having a control module, the control module having instructions that, when executed by the processor, cause the processor to:
control a potentiostat coupled to a clamp with a first plate and a second plate to apply a voltage to the first plate and the second plate of the clamp during an electrochemical impedance spectroscopy (EIS) test of a coating on a metal substrate disposed between the first plate and the second plate;
monitor a change in at least one of a phase angle and an impedance of the applied voltage in at least one of a wet environment, a dry environment, and a cyclically wet environment;
instruct the clamp to apply a constant pressure to the at least one of the coating and the metal substrate during the EIS test;
identify a change in substrate activation and coating performance of at least one of the coating and the metal substrate based, at least in part, on the change in the at least one of the phase angle and the impedance; and
identify a start of corrosion of the metal substrate in response to the change in the at least one of the phase angle and the impedance.
